(19) United States
(12) Patent Application Publication
(10) Pub. No.: US 2023/0196098 A1
(43) Pub. Date: Jun. 22, 2023

(54) SYSTEMS AND METHODS FOR TRAINING USING CONTRASTIVE LOSSES

(71) Applicant: NAVER CORPORATION, Gyeonggi-do (KR)

(72) Inventors: Rafael SAMPAIO DE REZENDE, Grenoble (FR); Arnaud SORS, Grenoble (FR); Sarah IBRAHIMI, Amsterdam (NL); Jean-Marc ANDREOLI, Meylan (FR)

(73) Assignee: NAVER CORPORATION, Gyeonggi-do (KR)

(21) Appl. No.: 17/949,180

(22) Filed: Sep. 20, 2022

Related U.S. Application Data
(60) Provisional application No. 63/292,495, filed on Dec. 22, 2021.

(51) Int. Cl. G06N 3/08

(52) U.S. Cl. CPC G06N 3/08

(57) ABSTRACT

A training system includes: a neural network configured to, using trained parameters, generate a first encoding based on an input query and second encodings based on candidate responses for the input query; and a training module configured to: train the trained parameters using hyperparameters; and jointly optimize the hyperparameters using coordinate descent and line searching, the hyperparameters including: a first hyperparameter indicative of a first weight value to apply based on positive interactions of entries of a distance matrix based on encodings; a second hyperparameter indicative of a second weight value to apply based on negative interactions of entries of the distance matrix generated based on the first and second encodings; and a third hyperparameter corresponding to a dimension of the distance matrix generated based on the first and second encodings.

### CROSS-REFERENCE TO RELATED APPLICATIONS

This application claims the benefit of U.S. Provisional Application No. 63/292,495, filed on Dec. 22, 2021. The entire disclosure of the application referenced above is incorporated herein by reference.

### FIELD

The present disclosure relates to information retrieval systems and methods and more particularly to systems and methods for training models of information retrieval systems using contrastive losses.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Use of computers, smartphones, and other Internet-connected devices has grown exponentially. Users utilize Internet-connected devices for many different tasks. For example, a user may utilize an Internet-connected device to search for local businesses, such as restaurants. As another example, a user may utilize an Internet-connected device to obtain directions to navigate to a desired location. As yet another example, a user may utilize an Internet-connected device to perform one or more building related functions, such as turn on a light within a building, adjust heating or cooling of a building, or open or close a garage door. As yet another example, a user may utilize an Internet-connected device to search for information on a topic, place an order, etc.

### SUMMARY

In a feature, a training system includes: a neural network configured to, using trained parameters, generate a first encoding based on an input query and second encodings based on candidate responses for the input query; and a training module configured to: train the trained parameters using hyperparameters; and jointly optimize the hyperparameters using coordinate descent and line searching, the hyperparameters including: a first hyperparameter indicative of a first weight value to apply based on positive interactions of entries of a distance matrix based on encodings; a second hyperparameter indicative of a second weight value to apply based on negative interactions of entries of the distance matrix generated based on the first and second encodings; and a third hyperparameter corresponding to a dimension of the distance matrix generated based on the first and second encodings.

In further features, the neural network is a convolutional neural network.

In further features, the neural network includes the ResNet-18 neural network.

In further features, the line searching includes bounded golden section line searching.

In further features, the training module is configured to: train the trained parameters based on minimizing a total contrastive loss determined based on a positive loss and an entropy loss; and balance the positive loss and the entropy loss based on the third hyperparameter.

In a feature, a search system includes: an encoder module configured to generate encodings based on an input query and candidate responses using parameters trained using hyperparameters optimized using coordinate descent and line searching; a distance module configured to generate a distance matrix including distance values between the candidate responses, respectively, and the input query; and a results module configured to select one of the candidate responses as a response to the input query based on the distance values.

In further features, the line searching includes bounded golden section line searching.

In further features, the encoder module includes a neural network configured to generate the encodings using the parameters trained using hyperparameters optimized using coordinate descent and line searching.

In further features, the neural network is a convolutional neural network.

In further features, the neural network includes the ResNet-18 neural network.

In further features, the hyperparameters include: a first hyperparameter indicative of a first weight value to apply based on positive interactions of entries of a distance matrix based on encodings; a second hyperparameter indicative of a second weight value to apply based on negative interactions of entries of the distance matrix generated based on the first and second encodings; and a third hyperparameter corresponding to a dimension of the distance matrix generated based on the first and second encodings.

In further features, the hyperparameters optimized jointly using coordinate descent and line searching.

In further features, the candidate responses include images.

In further features, the candidate responses include text.

In further features: the encoder module is configured to receive the input query from a computing device via a network; and the search system further includes a transceiver module configured to transmit the response including the one of the candidate responses to the computing device via the network.

In further features, the results module is configured to select one of the candidate responses as a response to the input query based on the distance values.

In a feature, a training method includes: by a neural network, using trained parameters, generating a first encoding based on an input query and second encodings based on candidate responses for the input query; training the trained parameters using hyperparameters; and jointly optimizing the hyperparameters using coordinate descent and line searching, the hyperparameters including: a first hyperparameter indicative of a first weight value to apply based on positive interactions of entries of a distance matrix based on encodings; a second hyperparameter indicative of a second weight value to apply based on negative interactions of entries of the distance matrix generated based on the first and second encodings; and a third hyperparameter corresponding to a dimension of the distance matrix generated based on the first and second encodings.

In further features, training the trained parameters includes: training the trained parameters based on minimizing a total contrastive loss determined based on a positive loss and an entropy loss; and balancing the positive loss and the entropy loss based on the third hyperparameter.

In further features, the neural network is a convolutional neural network.

In further features, the line searching includes bounded golden section line searching.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIG. 1 includes a functional block diagram of an example environment including a search system configured to provide search results in response to queries;

FIG. 2 includes a functional block diagram including an example implementation of a search module of the search system;

FIG. 3 includes a flowchart depicting an example method of receiving a query and providing a response to the query;

FIG. 4 includes a functional block diagram of a training system for training hyperparameters of an encoding module of a search system;

FIG. 5 includes an example illustration regarding training of the hyperparameters;

FIG. 6 illustrates a result grid for different hyperparameter values on mean average precision at R, where R is the number of relevant items for each query;

FIG. 7 is a functional block diagram of an example implementation of a navigating robot;

FIG. 8 is a flowchart depicting an example method of training the hyperparameters;

FIG. 9 includes an example graph of mAP as a function of a positive loss and an entropy loss;

FIG. 10 includes example graphs of hyper parameter optimization results as curves as described herein relative to other methods on four different training datasets;

FIG. 11 includes an example illustration of the hyperparameters and a set of optimal hyperparameters determined using the systems and methods described herein;

FIG. 12 includes an example illustration of a reparameterization matrix including direction vectors; and

FIG. 13 includes an example 3D view of three constraints on a set of hyperparameters h.

In the drawings, reference numbers may be reused to identify similar and/or identical elements.

### DETAILED DESCRIPTION

Cross-modal search involves receiving search queries in one modality regarding obtaining search results in another modality. For example, one type of cross-modal search involves receiving search queries including text regarding obtaining images that are most closely related to the text. Another type of cross-modal search involves receiving images and providing search results including text that is most closely related to the image.

Within-modal search involves receiving search queries in one modality regarding obtaining search results in that same modality. One example of retrieval in the same modality involves receiving an image and identifying images (or one or more objects in the images) that are most similar to a received image. Another example of retrieval in the same modality involves receiving text and identifying documents that include language are most similar to received text. While the examples of searching is provided, the present application is also applicable to other contrastive learning contexts, such as supervised representation learning.

In a search system (also referred to as an information retrieval system, or more simply a retrieval system), an encoder module is trained to generate encodings based on candidate results of a dataset. A distance module is configured to generate a pairwise distance scalars that relate closeness between an input query and ones of the candidate results. The distance scalars can be said to be a distance vector or matrix. The top k ones of the candidate results that are closest to the input query may be returned as search results, where k is an integer greater than zero.

Training the parameters of the encoder module using a contrastive loss may be expensive and time consuming as a large number of parameters of such a loss are independently tuned to achieve a target level of performance.

The present application involves jointly (together) optimizing hyperparameters that are used to train the encoder module to efficiently find a target balance between positive and negative training samples. The hyperparameters are optimized using coordinate descent and line searching. Examples of the hyperparameters that are optimized include a variable for a weight to be applied to one type of squares (e.g., black) of the distance matrix (e.g., negative interaction of samples), a variable for a weight to be applied to another type of squares (e.g., white) of the distance matrix (e.g., positive interaction of queries), and a variable for a size of the distance matrix.

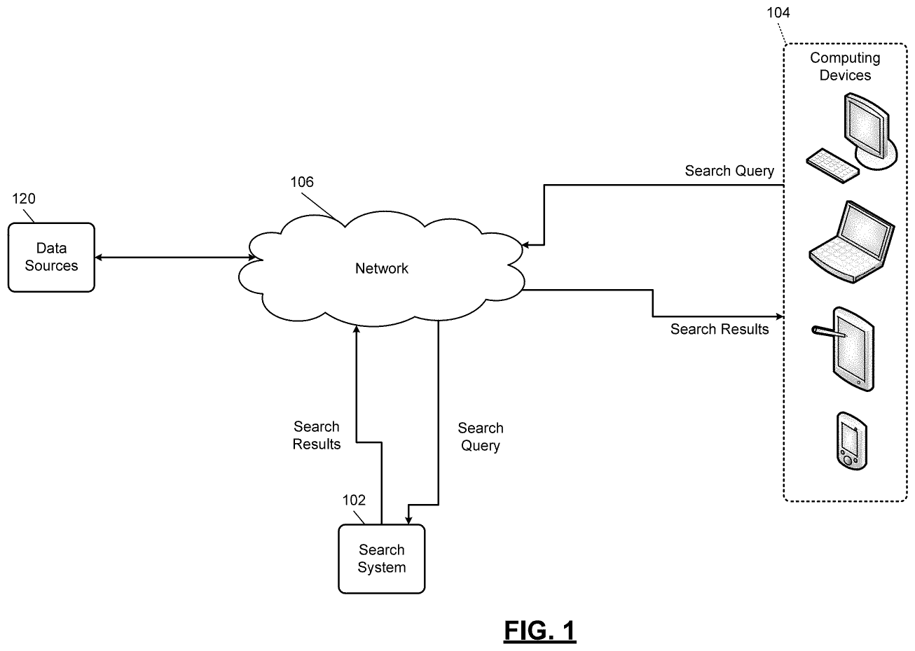

FIG. 1 includes a functional block diagram including a search system 102 configured to respond to queries with search results. The search system 102 is configured to receive queries from one or more computing device(s) 104 via a network 106. The search system 102 performs searches based on the queries, respectively, to identify one or more search results for the queries. The search system 102 may be configured to receive queries and provide search results in the same modality or in different modalities. In the example of different modalities, the search system 102 may receive queries in a first modality and provide search results in a second modality. For example, the first modality may be text and the second modality may be images. As another example, the first modality may be images and the second modality may be text. The search system 102 transmits the search results back to the computing devices 104 that transmitted the queries, respectively.

The computing devices 104 may output (e.g., display) the search results to users. The computing devices 104 may also display other information to the users. For example, the computing devices 104 may display additional information related to the search results, advertisements related to the search results, and/or other information. In various implementations, the computing devices 104 may audibly output the search results and the other information via one or more speakers. The search system 102 and the computing devices 104 communicate via a network 106.

A plurality of different types of computing devices 104 are illustrated in FIG. 1. The computing devices 104 include any type of computing devices that is configured to generate and transmit search queries to the search system 102 via the network 106. Examples of the computing devices 104 include, but are not limited to, smart (cellular) phones, tablet computers, laptop computers, and desktop computers, as illustrated in FIG. 1. The computing devices 104 may also include other computing devices having other form factors, such as computing devices included in vehicles, gaming devices, televisions, consoles (e.g., smart speakers without displays Amazon Echo, Google Home, Clova Friends mini) or other appliances (e.g., networked refrigerators, networked thermostats, etc.). In various implementations, the search system 102 may be implemented within a device, such as a navigating robot or vehicle, as discussed further below.

The computing devices 104 may use a variety of different operating systems. In an example where a computing device 104 is a mobile device, the computing device 104 may run an operating system including, but not limited to, Android, iOS developed by Apple Inc., or Windows Phone developed by Microsoft Corporation. In an example where a computing device 104 is a laptop or desktop device, the computing device 104 may run an operating system including, but not limited to, Microsoft Windows, Mac OS, or Linux. The computing devices 104 may also access the search system 102 while running operating systems other than those operating systems described above, whether presently available or developed in the future.

In some examples, a computing device 104 may communicate with the search system 102 using an application installed on the computing device 104. In general, a computing device 104 may communicate with the search system 102 using an application that can transmit queries to the search system 102 to be responded to (with search results) by the search system 102. In some examples, a computing device 104 may run an application that is dedicated to interfacing with the search system 102. In some examples, a computing device 104 may communicate with the search system 102 using a more general application, such as a web-browser application. The application executed by a computing device 104 to communicate with the search system 102 may display a search field on a graphical user interface (GUI) in which the user may input search queries. The user may input a search query, for example, by adding text to a text field using a touchscreen or physical keyboard, a speech-to-text program, or other form of user input. The user may input a search query, for example, by uploading an image stored in memory of the computing device 104.

A text query entered into a GUI on a computing device 104 may include words, numbers, letters, punctuation marks, and/or symbols. In general, a query may be a request for information identification and retrieval from the search system 102. For example, a query including text may be directed to providing an image that most closely matches the text of the query (e.g., includes a scene that is most closely described by the text of the query). A query including an image may be directed to providing text that most closely describes the content of the image.

A computing device 104 may receive a search result from the search system 102 that is responsive to the search query transmitted to the search system 102. In various implementations, the computing device 104 may receive and the search system 102 may transmit multiple search results that are responsive to the search query. In the example of the search system 102 providing multiple search results, the search system 102 may determine a confidence value (indicative of a likelihood of a search result is the most relevant search result to the search query) for each of the search results and provide the confidence values along with the search results to the computing device 104. The computing device 104 may display more than one of the multiple search results (e.g., all search results having a confidence value that is greater than a predetermined value), only the search result with the highest confidence value, the search results having the k highest confidence values (where k is an integer greater than one), etc.

The computing device 104 may be running an application including a GUI that displays the search result(s) received from the search system 102. The respective confidence value(s) may also be displayed. For example, the application used to transmit the search query to the search system 102 may also present (e.g., display or speak) the received search results(s) to the user via the computing device 104. As described above, the application that presents the received search result(s) to the user may be dedicated to interfacing with the search system 102 in some examples. In other examples, the application may be a more general application, such as a web-browser application.

The GUI of the application running on the computing device 104 may display or output the search result(s) to the user in a variety of different ways, depending on what information is transmitted to the computing device 104. In examples where the search results include a list of search results and associated confidence values, the search system 102 may transmit the list of search results and respective confidence values to the computing device 104. In this example, the GUI may display or output the search result(s) and the confidence value(s) to the user as a list of possible search results.

In some examples, the search system 102, or other computing system, may transmit additional information to the computing device 104 such as, but not limited to, applications and/or other information associated with the search results, the search query, or points of interest associated with the search results, etc. This additional information may be stored in a data store and transmitted by the search system 102 to the computing device 104 in some examples. In examples where the computing device 104 receives the additional information, the GUI may display the additional information along with the search result(s). In some examples, the GUI may display the search results as a list ordered from the top of the screen to the bottom of the screen by descending confidence value. In some examples, the search results may be displayed under the search field in which the user entered the search query.

In some examples, computing devices 104 may communicate with the search system 102 via a partner computing system. The partner computing system may include a computing system of a third party that may leverage the search functionality of the search system 102. The partner computing system may belong to a company or organization other than that which operates the search system 102. Example third parties which may leverage the functionality of the search system 102 may include, but are not limited to, internet search providers and wireless communications service providers. The computing devices 104 may send search queries to the search system 102 via the partner computing system. The computing devices 104 may also receive search results from the search system 102 via the partner computing system. The partner computing system may provide a user interface to the computing devices 104 in some examples and/or modify the user experience provided on the computing devices 104.

Data regarding search results from which the search system 102 determines the search results for queries may be stored in one or more data sources 120. The data sources 120 may include a variety of different data providers. The data sources 120 may include digital distribution platforms such as, but are not limited to, online news sources, websites, social networking sites (e.g., Facebook, Twitter, etc.), databases, and/or other types of data sources.

The data sources 120 may include, for example, a plurality of images and associated captions, respectively. In other words, each image includes an associated caption. The images and the captions are stored in memory of one or more of the data sources 120. While the example of the data sources 120 including images and captions is provided, the data sources 120 may include other data and/or other types of data.

The computing devices 104, the search system 102, and the data sources 120 may be in communication with one another via the network 106. The network 106 may include various types of networks, such as a wide area network (WAN) and/or the Internet. Although the network 106 may represent a long range network (e.g., Internet or WAN), in some implementations, the network 106 may include a shorter range network, such as a local area network (LAN). In one embodiment, the network 106 uses standard communications technologies and/or protocols. Thus, the network 106 can include links using technologies such as Ethernet, Wireless Fidelity (WiFi) (e.g., 802.11), worldwide interoperability for microwave access (WiMAX), 3G, 4G, 5G, Long Term Evolution (LTE), digital subscriber line (DSL), asynchronous transfer mode (ATM), InfiniBand, PCI Express Advanced Switching, etc. Similarly, the networking protocols used on the network 106 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 106 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In other examples, the network 106 can use custom and/or dedicated data communications technologies instead of, or in addition to, the ones described above.

Examples of search systems include visual question answering systems, visual common-sense reasoning systems, visual navigation systems, and other types of systems. Visual navigation systems, for example, collect images of an environment. Searches are performed to obtain information regarding the environment and/or features in the images located around the navigator (e.g., a vehicle), for example, as discussed further below.

The present application involves training of a search module using contrastive loss on a training dataset.

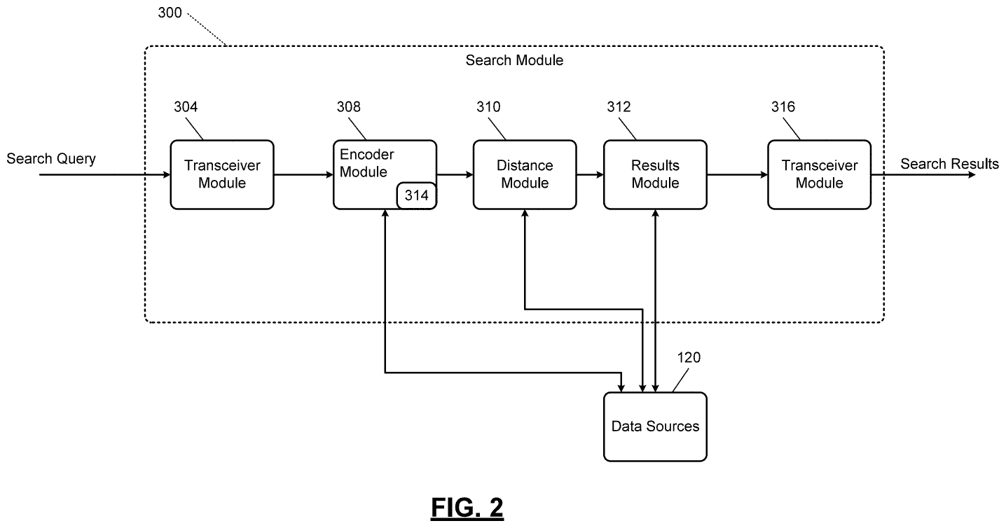

FIG. 2 is a functional block diagram including an example implementation of a search module 300 of the search system 102. A first transceiver module 304 receives a search query from a computing device 104.

An encoder module 308 encodes/embeds the search query using an embedding function 314. The encoder module 308 also encodes/embeds candidate search results from the data sources 120 using the embedding function 314. The embedding function 314 is discussed in further detail below. The encoder module 308 may include a neural network that performs the embedding/encoding, such as a convolutional neural network (CNN) or another suitable type of neural network. As an example, the neural network may be the ResNet-18 neural network or another suitable type of neural network.

A distance module 310 determines a distance matrix based on the embeddings/encodings of the candidate search results and the search query. The distance matrix includes distance values (scalars) that correspond to closenesses between the candidate search results, respectively, and the search query. Smaller distance values may be indicative of closer matching between a candidate search result and the search query and vice versa. The distance values may be represented by colors in various implementations. For example, a first color may indicate a positive match with a candidate search result, a second color may indicate a negative match with a candidate search result, and color may transition from the second color toward the first color as closeness with the candidate search result increases and vice versa.

A results module 312 determines search results for the search query based on the distance matrix. The results module 312 may determine the search results for the search query as the k candidate search results from the data sources 120 with the k smallest distance values, respectively, where k is an integer greater than zero. Training of the embedding function 314 is discussed further below. In various implementations, the data sources 120 may be stored within the search module 300 or within the same device as the search module 300.

A second transceiver module 316 transmits the determined search results for the search query back to the computing device 104 via the network 106. In various implementations, the second transceiver module 316 may be omitted, and the first transceiver module 304 may transmit the search results back to the computing device 104 from which the search query was received. In various implementations, such as in the example of a navigating robot, the first and second transceivers 304 and 316 may be omitted.

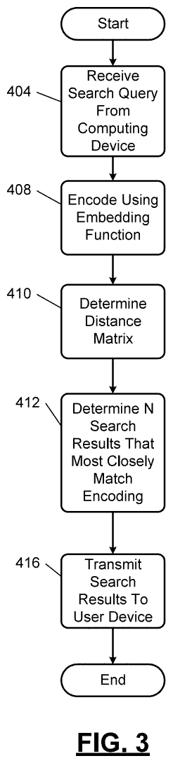

FIG. 3 includes a flowchart depicting an example method of receiving a search query and providing search results. The example of FIG. 3 may be performed by the search module 300.

Control begins with 404 where the search module 300 receives a search query, such as from a computing device 104. The search query may include, for example, text, an image, or sound.

At 408, the search module 300 encodes the search query using the embedding function 314. At 410, the search module 300 generates the distance matrix by comparing the encodings of the candidate search results with the encoding of the search query and determining the distance values based on the comparisons, respectively.

At 412, the search module 300 determines the k candidate search results that most closely match the search query based on the distance matrix, such as the k candidate search results with the k smallest distance values, respectively. In various implementations, the search module 300 may perform nearest neighbor searching, and 410 and 412 may be combined.

At 416, the search module 300 transmits the search results to the computing device 104 that transmitted the search query. The search results may include, for example, k images, k links (e.g., hyperlinks), and/or other suitable information.

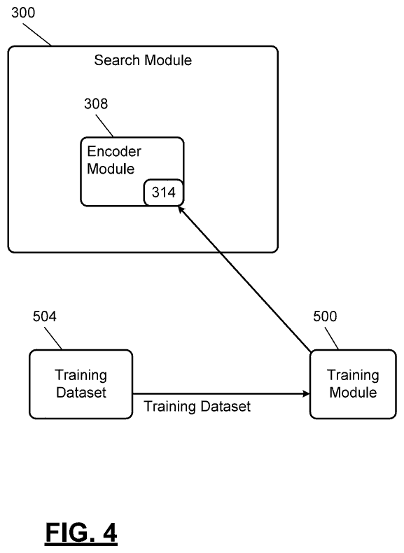

FIG. 4 includes a functional block diagram of a training module 500 configured to train the embedding function 314. The training module 500 may train the embedding function 314, for example, based on minimizing a contrastive loss.

The training module 500 trains the embedding function 314 using a training dataset 504 stored in memory. Once trained based on optimized hyperparameters, the training module 500 stores the parameters of the embedding function 314 in the search module 300.

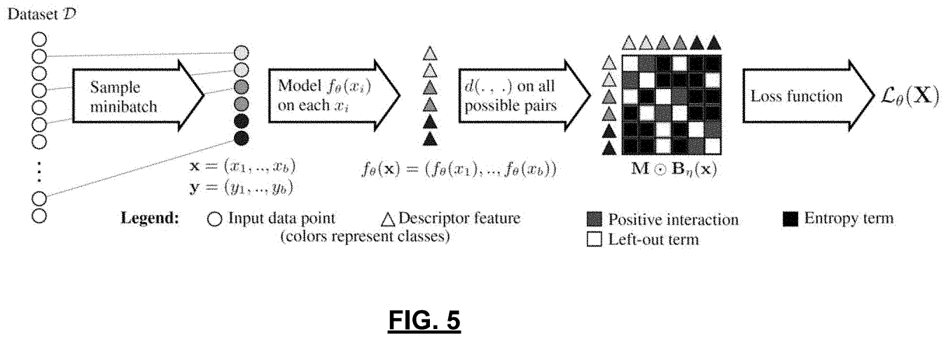

FIG. 5 includes an example illustration regarding the training.

Consider the training dataset D is given, where each item of D=(xi,yi), i∈[[1, N]] includes an instance xi and a label yi. In the example of self-supervised training, the label may be omitted. The training module 500 first samples a subset from the training dataset 504 to obtain a minibatch of size b. A minibatch (x, y) where the labels y are arranged by pairs, such as shown in the example of FIG. 5. The training module 500 inputs the minibatch to the encoder module 308.

Labels for deep metric learning (DML)

$$y ∈ 〚 1 , \frac{b}{s} 〛$$

may be obtained from class labels sampled by groups of two. Labels for self-supervised learning (SSL) may be artificial and may be determined using data augmentations. ƒ(·, θ) stands for the embedding function ƒ parameterized by θ. Second, minibatch embeddings zi=∥ƒ_{θ}(xᵢ)∥ are obtained by applying the embedding function f on each data point xᵢ. Third, the distance module 310 calculates between all possible pairs within the minibatch to generate the distance matrix for the minibatch.

The distance function used by the distance module 310 to determine the distance values may be a non-parametric distance function, such as the Euclidean distance function or the cosine distance function. M may be the pairwise distance matrix of the minibatch x: Mᵢⱼ=(zᵢ,zⱼ). For each training batch (minibatch), a proportion η∈[0,1] of all possible negative pairs is used in the loss function, in addition to all positive pairs. B_{η}(x) is a Boolean selection mask.

Based on the distance matrix, the training module 500 calculates a loss using a loss function as discussed further below. The training module 500 may minimize the contrastive loss using stochastic gradient descent (SGD) without momentum in various implementations.

Two pair-based contrastive loss functions are described below. A first contrastive margin loss introduced may be defined for any pair of descriptors (zᵢ, zⱼ) and has the form

[symbol]

_{i,j}=1_{y}_{ᵢ}_{=y}_{ⱼ} [symbol] ₚ(zᵢ, zⱼ)+1_{y}_{ᵢ}_{≠y}_{ⱼ} [symbol] ₑ(zᵢ, zⱼ)

[symbol]

ₚ(zᵢ, zⱼ)=d(zᵢ, zⱼ)^{q},

[symbol]

ₑ(zᵢ, zⱼ)=max(0,m−d(zᵢ, zⱼ))^{q}, (1)

where m>0 is the margin and the distance exponent q is a predetermined value, such as 1 or 2. p is also a predetermined value, such as 1.

A second loss [symbol] _{i,j} may be for SSL and includes a modification of a multi-class N-pair loss used in DML, namely the use of a temperature parameter τ. Scaling may or may not be used. Given a positive pair (zᵢ,zⱼ) and an ensemble E of entropy terms, the loss for the positive pair can be described by

$${ℓ}_{i , j} = - log \frac{exp ( \frac{sim ( {z}_{i} , {z}_{j} )}{τ} )}{{\sum }_{k ∈ {ε}_{i , j}} exp ( \frac{sim ( {z}_{i} , {z}_{k} )}{τ} )} , \qquad ( 2 )$$

where sim(.,.)=1−d(.,.) is the cosine similarity, and the ensemble of entropy terms may be ε_{i,j}={∈ [symbol] 1, b [symbol] |yₖ≈yᵢ}∪{i} meaning that for the positive pair (i,j) the denominator includes negative pairs involving I and the pair (i,j). While these examples are provided, the present application is also applicable to other options.

Above describes how the two contrastive losses apply on a pair (zᵢ,zⱼ). A minibatch of size b contains b² pairs amongst which O(b) positive pairs and O(b²) negative pairs. Positive pairs are for items that match (e.g., two images of oranges), while negative pairs are items that do not match (e.g., one image including the Eiffel Tower and one image including an orange). Regarding the total loss on the minibatch, for the contrastive margin loss (the first contrastive loss above), the training module 500 may use a global average loss on all pairs. The relative contribution of positive versus negative pairs to the total loss may then depend on batch size. In various implementations, the training module 500 may separately average for the negative pairs and positive pairs and determine the total loss based on the averages and respective predetermined weight values. For example, the training module 500 may multiply the averages with the respective predetermined weights and sum the resulting products. In such implementations, the relative contributions do not depend on batch size, but may be fixed predetermined values, which may or may not be optimal values.

For the second loss discussed above, the relative contributions of the positive versus entropy terms are already defined in each [symbol] _{i,j}, but their ratio may or may not be an optimal value.

The first and second losses above may be written as decomposition over two sub-losses using a balance hyperparameter. For simplicity, assume each label present in the training dataset appears exactly n times, such as n=2.

Regarding the first loss, denote P={(i, j)∈ [symbol] 1, b [symbol] ²|yᵢ=yⱼ} as the ensemble of positive pairs and ε={(i, j)∈ [symbol] 1, b [symbol] ²|yᵢ≈yⱼ|B_{η}_{ᵢⱼ}=1} as the ensemble of negative terms in a minibatch. P includes b(n−1) terms and ε includes b(b−n)η terms. [symbol] ₚ and [symbol] ₑ are the average values of [symbol] ₚ and [symbol] ₑ over the positive and negative pairs, respectively.

[symbol]

ₚ(z)= [symbol] _{i,j)˜∪(P)}[ [symbol] ₚ(zᵢ, zⱼ)]

[symbol]

ₑ(z)= [symbol] _{(i,j)˜∪(ε)}[ [symbol] ₑ(zᵢ, zⱼ)] (3)

Expected values [symbol] _{(z)}[ [symbol] ₚ] and [symbol] _{(z)}[ [symbol] ₑ] do not depend on b, and similarly for gradients [symbol] _{(z)}[∇_{θ} [symbol] ₚ] and [symbol] _{(z)}[∇_{θ} [symbol] ₑ]. The total loss and SGD update can be determined by the training module 500 based on or equal to a weighted sum of

[symbol]

(z)=λₚ [symbol] ₚ(z)+λₑ [symbol] ₑ(z),

dθ(z)=α∇_{θ} [symbol] (z)=αλₚ∇_{θ} [symbol] ₚ(z)+αλₑ∇_{θ} [symbol] ₑ(z) (4) and

where λₚ and λₑ are predetermined weight values.

Assuming that n=n₀ and η=η₀ are fixed, the dynamics of the optimization problem can be uniquely characterized by three hyperparameters discussed above Λₚ=αλₚ, Λₑ=αλₑ, and b. Λₚ is the variable for the weight to be applied to one type of squares (e.g., black) of the distance matrix, Λₑ is the variable for the weight to be applied to another type of squares (e.g., white) of the distance matrix, and b is the variable for the size of the distance matrix

h=(Λₚ, Λₑ, b) and g:h→g(h) is the function associated with a hyperparameter configuration the value of expected evaluation performance of the search module 300.

In the example of a global-average minibatch loss using all b² negative terms,

$$ℒ = \frac{1}{{b}^{2}} ( \sum {ℓ}_{p} + \sum {ℓ}_{e} )$$

Matching the

$$\frac{1}{{b}^{2}}$$

term witn equation (3reveals that

$${λ}_{p} = \frac{n - 1}{b} and {λ}_{e} = \frac{b - n}{b} .$$

With this normalization, only two dimensions of the problem space h are explored.

$${C}_{global} = \{ ( {Λ}_{p} , {Λ}_{e} , b ) \vert \frac{{λ}_{p}}{{λ}_{e}} = \frac{n - 1}{b - n} ∼ \frac{1}{b} , η = 1 \}$$

is the ensemble of configurations reachable with global average. Similarly,

$${C}_{separate} = \{ ( {Λ}_{p} , {Λ}_{e} , b ) \vert \frac{{λ}_{p}}{{λ}_{e}} = 1. , η = 1 \}$$

is the ensemble of configurations reachable with separate average.

Regarding the second loss, p={(i, j)∈ [symbol] 1,b [symbol] ²|yᵢ=yⱼ} is the ensemble of positive pairs. The total loss may be defined as a mean (average) over all positive pairs

[symbol]

_{std}(z)= [symbol] _{(i,j)˜∪(P)}[ [symbol] _{i,j}] (6)

The numerator and the denominator of each the numerator and denominator of each [symbol] _{i,j} may be split, and [symbol] ₚ and [symbol] ₑ may be defined as

$${\overline{ℓ}}_{p} ( z ) ≡ - {𝔼}_{( i , j ) ∼ ⋃ ( P )} [ \frac{s i m ( {z}_{i} , {z}_{k} )}{τ} ] and \qquad ( 7 )$$

$${\overline{ℓ}}_{e} ( z ) ≡ - {𝔼}_{( i , j ) ∼ ⋃ ( P )} [ log {\sum }_{{B}_{\begin{matrix}η ik = 1 \\ k ∈ {ε}_{i , j}\end{matrix}}} exp ( \frac{s i m ( {z}_{i} , {z}_{k} )}{τ} ) ]$$

As described above, the expected values do not depend on b.

The total loss and the associated SGD update rule can be defined similarly to the first loss

[symbol]

(z)=λₚ [symbol] ₚ(z)+λₑ [symbol] ₑ(z), (8) and

dθ(z)=α∇_{θ} [symbol] (z)=αλₚ∇_{θ} [symbol] ₚ(z)+αλₑ∇_{θ} [symbol] ₑ(z) (9)

Assuming that n=n₀ and η=η₀ are fixed, the dynamics of the optimization problem can be uniquely characterized by three hyperparameters discussed above Λₚ=αλₚ, Λₑ=αλₑ, and b. λₚ is the variable for the weight to be applied to one type of squares (e.g., black) of the distance matrix, λₑ is the variable for the weight to be applied to another type of squares (e.g., white) of the distance matrix, and b is the variable for the size of the distance matrix.

The training module 500 searches for the values of the 3 hyperparameters (Λₚ, Λₑ, and b) as follows. Above discusses decomposing each contrastive loss into a two-task problem, and parameterized the optimization problem with hyperparameters h=(Λₚ, Λₑ, and b). In the following, the value of h will be referred to as a balance and involves the relative contributions of the positive to the entropy term. The hyperparameters are trained and tuned jointly at a joint learning rate and batch size. The training module 500 minimizes the number of training runs (e.g., mini batches) needed to optimize h, such as using hyperparameter optimization (HPO).

Regarding the training, the training module 500 may execute Algorithm 1 below to execute coordinate-descent HPO and execute Algorithm 2 to perform line searching to train the hyperparameters h=(Λₚ, Λₑ, and b). The other parameters of the encoder module 308 may be held constant during the training.

Algorithm 1: Coordinate- descent HPO

```
input : Starting point h₀
    matrix of directs A
    budgets per direction (c₀, c₁, c₂)
    total budget c
    search space H =
    (Λₚ_{ₘᵢₙ}, Λₚ_{ₘₐₓ}, Λₑ_{ₘᵢₙ}, Λₑ_{ₘₐₓ}, bₘᵢₙ, bₘₐₓ)
output : best configuration h = (Λₚ, Λₑ, b)
initialization: starting point and current direction
h ← h₀
i ← 0
while not finished (c) do
  |Perform a line search of cᵢ trails:
  | h ← line_search (h, A[i, :], cᵢ, H)
  |i ← (i + 1)%3
  |Optionally update budget: cᵢ ← cᵢ (history)
end
```

Algorithm 2: (bounded golden-section) line_search

```
input : Starting point h_{I}= (Λₚ_{ₗ} Λₑ_{ₗ}, bₗ)
    search direction aₗ
    budget (number of trials)c_{I}
    search space H
output : best configuration found on this line:
    h = (Λₚ, Λₑ b)
Initialization: starting point h ← h_{I}, h ← hₗ, γ = 0
Equation of current line is ( [symbol]   ) : hₗ + γα
Determine search_bracket [γₘᵢₙ, γₘₐₓ ] = ( [symbol]   ) ∩ H
for c runs do
  |Perform a golden - section step:
  |(γₘᵢₙ, γ, γₘₐₓ) ← step(γₘᵢₙ, γ, γₘₐₓ)
  |h ← hₗ + γα
end
```

Algorith 1 involves inputs including a starting point h0, a matrix of directions a, budgets per direction (c₀, c₁, c₂), a total budget c, and a search space H. A may be a 3×3 linear re-parameterization matrix which lines are the direction of a new coordinate system in log H in which coordinate descent will be performed. An example of A may be

$$A = ( \begin{matrix}- 1 & 1 & 0 \\ 1 & 1 & 0 \\ 0 & 0 & 1\end{matrix} ) ,$$

which corresponds to the directions above, namely the first line is the balance direction, the second line corresponds to varying the joint learning rate, and the third line is a batch size. H is the search space in which coordinate descent (an HPO) will be performed. Denoting r the coordinates in the new coordinate system yields A log h^{T}=τ, with

$$log {h}^{T} = ( \begin{matrix}log {Λ}_{p} \\ log {Λ}_{e} \\ log b\end{matrix} )$$

and

$$r = ( \begin{matrix}{r}_{1} \\ {r}_{2} \\ {r}_{3}\end{matrix} ) .$$

In this coordinate system, the coordinate descent involves the training module 500 performing successive line searches alternating in the three directions. Each line search involves the training module 500 finding a (e.g., optimal) configuration on the present line. M may be an evaluation metric that associates test performance to a value of h or r, and hₒₚₜ and rₒₚₜ represent globally optimal configurations of h and r, respectively. M may be close to its quadratic (second order) approximation (assuming positive and therefore convex). If the directions A corresponds to the eigenvectors of the hessian

$$\frac{\partial ∈ M}{\partial {r}^{2}} ,$$

the coordinate descent can reach rₒₚₜ in only three line searches. This indicates that the choice of A is important to minimize training.

For the training, the training module 500 initializes h to h₀ and initializes a counter I to 1, as in algorithm 1. The training module 500 performs line searching of ci trials. Algorithm 2 details the line searching.

The inputs for Algorithm 2 involve a starting point h_{ι}=(Λ_{pι}, Λ_{eι}, b₇₆), a search direction aₗ, the budget (number of trials) cₗ, and the search space H. Using Algorithm 2, the best configuration of h on this line is determined by the training module 500. The training module 500 initializes h and γ and determines an equation for the present line using h and γ. The training module 500 breaks the line into segments (determines a segment of the line) defined by γₘᵢₙ and γₘₐₓ. For the budged number of trials, the training module 500 performs a bounded golden section search for h. The training module 500 performs Algorithm 2 for each of the 3 line directions. Once the optimal values of h are determined, the training module 500 stores the values of the parameters in the encoder module 308 for use for information (e.g., text, image) retrieval.

The coordinate descent of Algorith 1 involves an alternation of successive line searches. While the example of a bounded golden section search is described, the present application is also applicable to other types of line searching for optimum values. Bounded golden section search is a type of trisection search that uses the golden ratio for narrowing to determine the optimal values. The bounded golden section searching has fast convergence and increases computational efficiency.

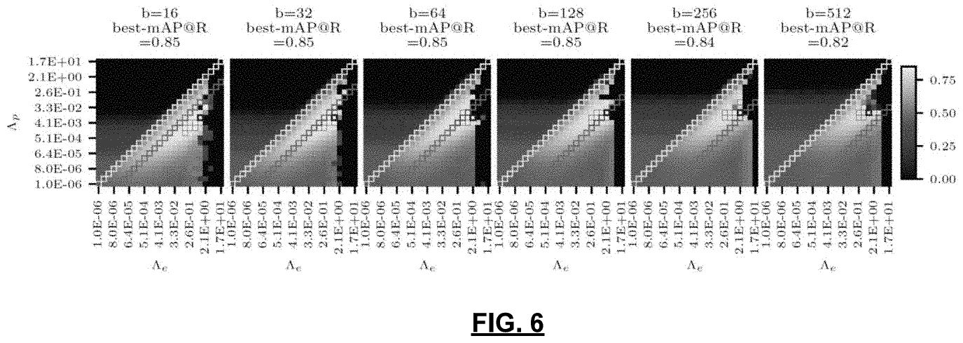

Test performance may be viewed as a function of h∈H as a fixed-range cubic subspace H. The Omniglot dataset may be used as a training dataset for image search/retrieval and train to minimize the first loss discussed above. FIG. 6 shows the result grid for different values of h on mAP@R (mean average precision at R, where R is the number of relevant items for each query). The first four batch sizes show an almost equal best performance of 0.85 mAP@R, although best performance may slightly degrade for larger batch sizes. The grey and beige diagonal lines represent the two dimensional (2D) subspace accessible without an additional balance hyperparameter and using a global-average loss (resp. separate-average loss). The grey diagonal lines change position with batch size because the relative proportion of positive versus entropy terms changes. One grey diagonal line and none of the beige diagonal lines may provide include the best configuration for its batch size. In terms of HPO, the performance landscape seems to be relatively simple, and approximately convex around the optimum. Searching only locally around the present best configuration may eventually lead to the best possible configuration of h. An acceptable zone around the best configuration also seems reasonably large, although it is near the limit where training becomes unstable because the learning rate on the entropy term may become high. Also, the 3D pattern has one main direction do, corresponding to varying Λₚ and Λₑ jointly, so focus first on tuning orthogonal to this direction may minimize training. Also, in the chosen hyperparameter range, the value of the batch size may have minimal importance. Incidentally, the direction which is orthogonal to do and keeps b constant is the balance direction.

Regarding sampling, for DML, the training module 500 may implement a 2 per class strategy. Given a batch size of b, the training module may randomly select b/2 unique classes (classifications) from each of which 2 samples are randomly selected. For SSL, the training module may use two transform views for each training image.

The training module 500 trains the encoding module 304 using stochastic gradient descent and line searching as described above. For testing/experimentation, Λₚ and Λₑ may be varied, such as between 10⁻⁶ and 17 or another suitable range. Λₚ and Λₑ may be varied, for example, incrementally, such as by multiplicative increments of 2. b may be fixed or variable. For example, b may be varied between 16 and 512 or another suitable range. b may be varied, for example, incrementally, such as by multiplicative increments of 2. In various implementations, b may be fixed and only Λₚ and Λₑ may be varied. In various implementations, the batch size and the learning rate during training may be varied by the training module 500. Turning only the learning rate and maintaining a fixed batch size may cause a performance drop.

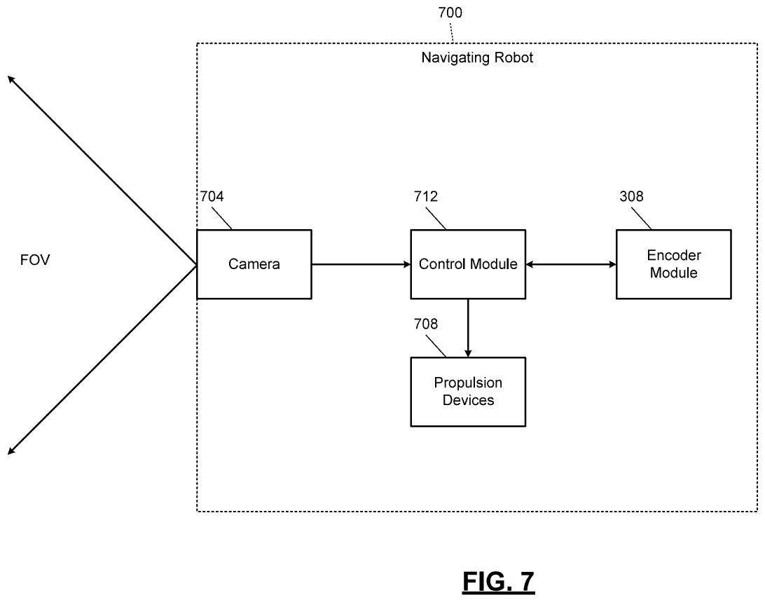

FIG. 7 is a functional block diagram of an example implementation of a navigating robot 700. The navigating robot 700 includes a camera 704 that captures images within a predetermined field of view (FOV) in front of the navigating robot 700. The predetermined FOV may be less than or equal to 360 degrees around the navigating robot 700. The navigating robot 700 may therefore have less than or equal to a full 360 degree FOV around the navigating robot 700. The operating environment of the navigating robot 700 may be an indoor space, i.e., within a building, parking garage, cave or other enclosure, or an outdoor space.

The camera 704 may be, for example, a grayscale camera, a grayscale—D camera, a red, green, blue (RGB) camera, an RGB-D camera, or another suitable type of camera. A grayscale-D camera includes a depth (D) component. An RGB-D camera also includes a depth (D) component. In various implementations, the navigating robot 700 may include only the (one) camera 704 and not include any other visual imaging cameras and/or sensors. Alternatively, the navigating robot 700 may include one or more other cameras and/or one or more other types of sensors.

The navigating robot 700 includes one or more propulsion devices 708, such as one or more wheels, one or more treads, one or more moving legs, and/or one or more other types of devices configured to propel the navigating robot 700 forward, right, left, up and/or down. A combination of two or more of the propulsion devices 708 may be used to propel the navigating robot 700 forward, to turn the navigating robot 700 right, to turn the navigating robot 700 left, and/or to elevate the navigating robot 700 vertically up or down.

The navigating robot 700 includes a control module 712 that is configured to control the propulsion devices 708 to navigate the operating environment, such as from a starting location to a goal location, without colliding with any objects based on input from the camera 704 and using the encoder module 308 trained as described herein for image retrieval (e.g., for localization). The encoder module 308 and an image dataset is stored in memory of the navigating robot 700.

The camera 704 may update at a predetermined frequency, such as 60 hertz (Hz), 120 Hz, or another suitable frequency. The encoder module 308 may be used to identify a closest image to an image from the camera 704, for example, to determine a present location of the navigating robot 700 or to identify an object in the field of view of the navigating robot 700. The control module 712 may control the propulsion devices 708 based on the present location of the navigating robot 700. For example, the control module 712 may actuate the propulsion devices 708 to move the navigating robot 700 forward by a predetermined distance based on the present location. The control module 712 may actuate the propulsion devices 708 to turn the navigating robot 700 to the right by a predetermined angle based on the present location. The control module 712 may actuate the propulsion devices 708 to turn the navigating robot 700 to the left by a predetermined angle based on the present location. The control module 712 may not actuate the propulsion devices 708 to not move the navigating robot 700 based on the present location. While example movements are provided, other movements are also possible.

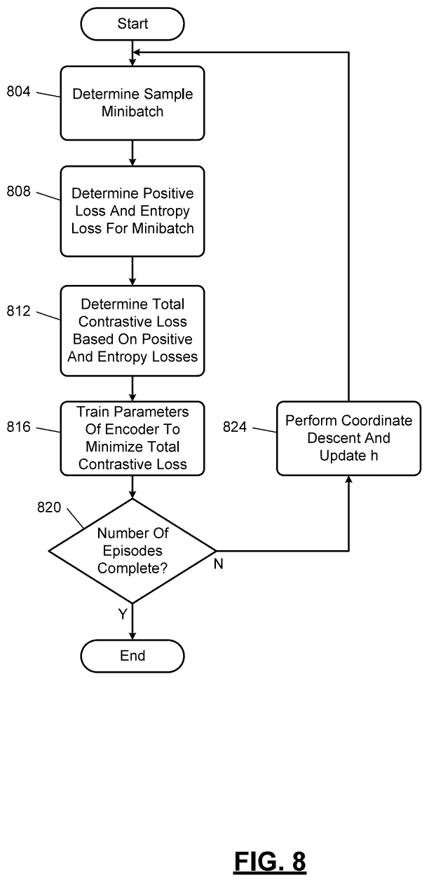

FIG. 8 is a flowchart depicting an example method of training the encoder module 308 and optimizing the hyperparameters. Control begins with 804 where the training module 500 selects a minibatch of the samples of the training dataset 504. The hyperparameters may be initialized to predetermined values to begin. At 808, the training module 500 feeds the samples of the minibatch into the encoder module 308 with its then present parameters. The training module 500 determines a positive loss [symbol] ₚ and an entropy loss [symbol] ₚ as described above based on the output of the distance module 310 based on the input samples.

At 812, the training module 500 determines the total contrastive loss [symbol] as discussed above based on the positive loss and the entropy loss. At 816, the training module 500 selectively adjusts the parameters of the encoder module 308 based on minimizing the total contrastive loss.

At 820, the training module 500 determines whether a predetermined number of episodes (e.g., each including a predetermined number of mini batches) have been input for the training. Additionally or alternatively, the training module 500 may determine whether the total contrastive loss is less than a predetermined value. If 820 is true, control may end. If 820 is false, control continues with 824.

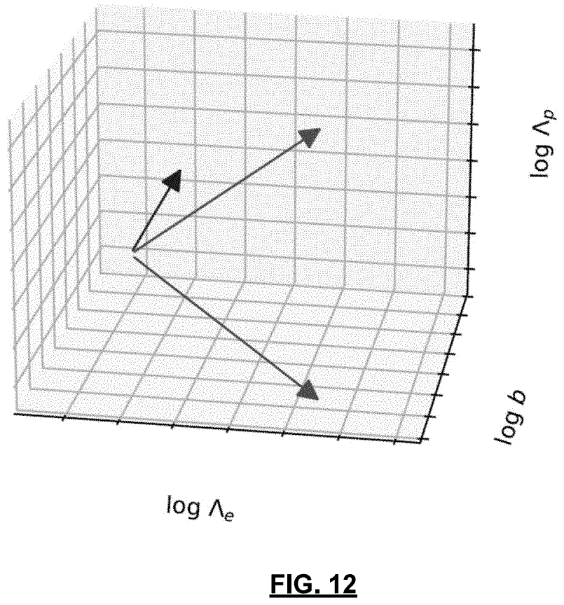

At 824, the training module 500 optimizes (e.g., fine tunes) the hyperparameters jointly using coordinate descent as discussed above. This involves line searching. Each loop performs one step of the coordinate descent, and the coordinate descent is completed via completion of the episodes. An example of the coordinate descent can be found in Algorithm 1. An example of the line searching can be found in Algorithm 2. The line searching involves extending lines in different directions from a starting location of the hyperparameters in budgeted (predetermined) numbers of increments and determining the hyperparameters jointly based on the lines using golden section selection. FIG. 12 includes an example illustration of a reparameterization matrix including direction vectors (line segments) extending in different directions from a starting location. Coordinates in FIG. 12 are denoted by [symbol] where [symbol] =Alogh^{T}. Control returns to 804 to continue the training of the parameters of the encoder module 308 and the optimization of the hyperparameters (Λₚ, Λₑ, and b).

Once trained, the encoder module 308 can be used, such as described above for information retrieval, such as image searching, text searching, etc.

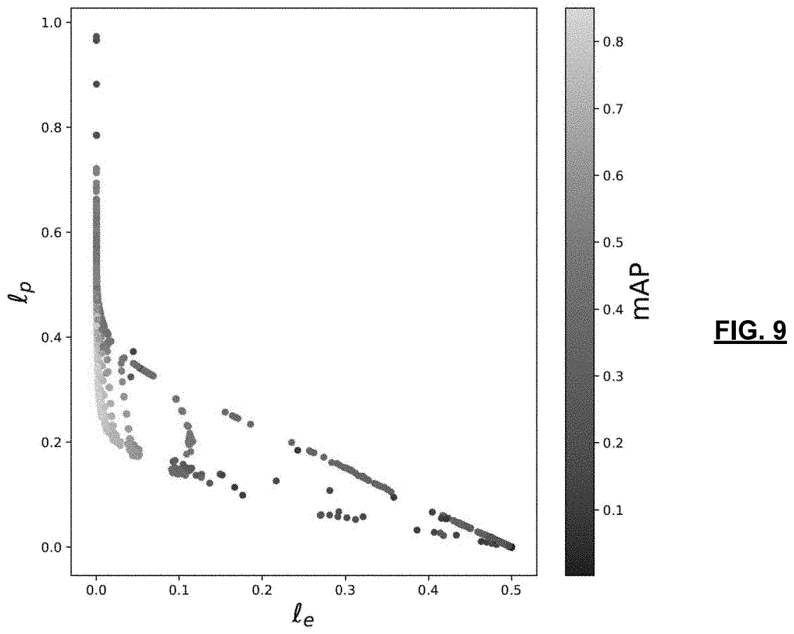

FIG. 9 includes an example graph of mAP as a function of the positive loss and the entropy loss. FIG. 9 illustrates that minimizing both the positive loss and the entropy loss increases mAP.

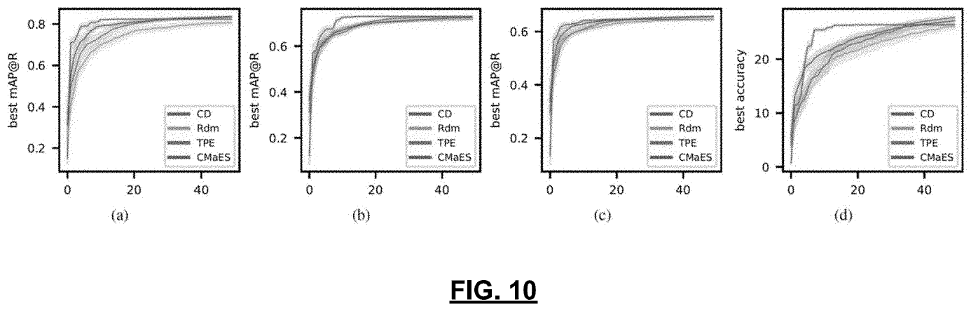

FIG. 10 includes example graphs of HPO results 2D curves as described herein (denoted CD) relative to other methods on four different training datasets. Reported numbers were obtained from the average of 80 HPO trajectories. FIG. 10 illustrates that the systems and methods described herein (CD) provide consistent improvements over the other methods across different datasets and across the positive and entropy losses.

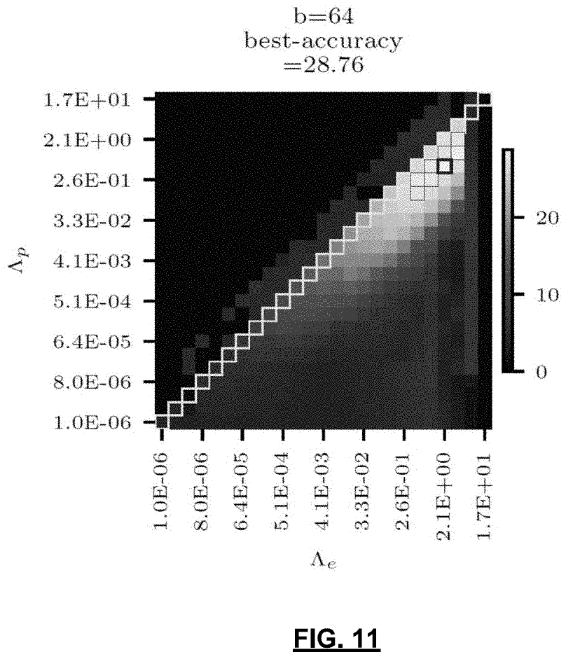

FIG. 11 includes an example illustration of the hyperparameters and a set of optimal hyperparameters (b=64) determined using Algorithms 1 and 2 above. As illustrated, the optimal hyperparameters do not fall on the main diagonal reachable using a standard loss balance. The optimal (optimized) hyperparameters, however, are found using the line searching described above.

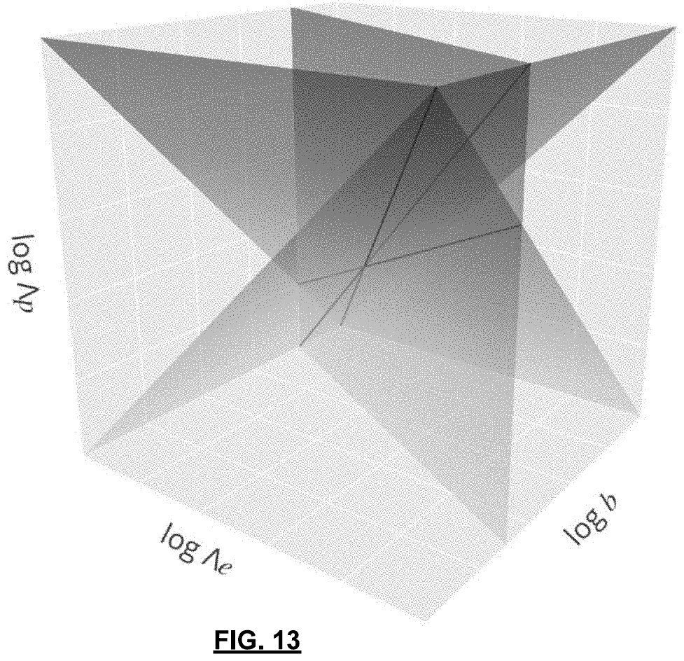

FIG. 13 includes an example 3D view of three constraints on h. [symbol] is in red, [symbol] is in blue, and [symbol] _{eq} is in green. Each plane represents the set of points where the associated constraint is zero. To decouple the search (coordinate descent), the training module 500 may perform the coordinate descent along directions which vary only one constraint at a time.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A training system comprising:
a neural network configured to, using trained parameters, generate a first encoding based on an input query and second encodings based on candidate responses for the input query; and
a training module configured to:
train the trained parameters using hyperparameters; and
jointly optimize the hyperparameters using coordinate descent and line searching,
the hyperparameters including:
a first hyperparameter indicative of a first weight value to apply based on positive interactions of entries of a distance matrix based on encodings;
a second hyperparameter indicative of a second weight value to apply based on negative interactions of entries of the distance matrix generated based on the first and second encodings; and
a third hyperparameter corresponding to a dimension of the distance matrix generated based on the first and second encodings.

2. The training system of claim 1 wherein the neural network is a convolutional neural network.

3. The training system of claim 2 wherein the neural network includes the ResNet-18 neural network.

4. The training system of claim 1 wherein the line searching includes bounded golden section line searching.

5. The training system of claim 1 wherein the training module is configured to:
train the trained parameters based on minimizing a total contrastive loss determined based on a positive loss and an entropy loss; and
balance the positive loss and the entropy loss based on the third hyperparameter.

6. A search system, comprising:
an encoder module configured to generate encodings based on an input query and candidate responses using parameters trained using hyperparameters optimized using coordinate descent and line searching;
a distance module configured to generate a distance matrix including distance values between the candidate responses, respectively, and the input query; and
a results module configured to select one of the candidate responses as a response to the input query based on the distance values.

7. The search system of claim 6 wherein the line searching includes bounded golden section line searching.

8. The search system of claim 6 wherein the encoder module includes a neural network configured to generate the encodings using the parameters trained using hyperparameters optimized using coordinate descent and line searching.

9. The search system of claim 8 wherein the neural network is a convolutional neural network.

10. The search system of claim 8 wherein the neural network includes the ResNet-18 neural network.

11. The search system of claim 6 wherein the hyperparameters include:
a first hyperparameter indicative of a first weight value to apply based on positive interactions of entries of a distance matrix based on encodings;
a second hyperparameter indicative of a second weight value to apply based on negative interactions of entries of the distance matrix generated based on the first and second encodings; and
a third hyperparameter corresponding to a dimension of the distance matrix generated based on the first and second encodings.

12. The search system of claim 6 wherein the hyperparameters optimized jointly using coordinate descent and line searching.

13. The search system of claim 6 wherein the candidate responses include images.

14. The search system of claim 6 wherein the candidate responses include text.

15. The search system of claim 6 wherein:
the encoder module is configured to receive the input query from a computing device via a network; and
the search system further includes a transceiver module configured to transmit the response including the one of the candidate responses to the computing device via the network.

16. The search system of claim 6 wherein the results module is configured to select one of the candidate responses as a response to the input query based on the distance values.

17. A training method comprising:
by a neural network, using trained parameters, generating a first encoding based on an input query and second encodings based on candidate responses for the input query;
training the trained parameters using hyperparameters; and
jointly optimizing the hyperparameters using coordinate descent and line searching,
the hyperparameters including:
a first hyperparameter indicative of a first weight value to apply based on positive interactions of entries of a distance matrix based on encodings;
a second hyperparameter indicative of a second weight value to apply based on negative interactions of entries of the distance matrix generated based on the first and second encodings; and
a third hyperparameter corresponding to a dimension of the distance matrix generated based on the first and second encodings.

18. The training method of claim 17 wherein training the trained parameters includes:
training the trained parameters based on minimizing a total contrastive loss determined based on a positive loss and an entropy loss; and
balancing the positive loss and the entropy loss based on the third hyperparameter.

19. The training method of claim 17 wherein the neural network is a convolutional neural network.

20. The training method of claim 17 wherein the line searching includes bounded golden section line searching.
